(19) United States
(12) Patent Application Publication
(10) Pub. No.: US 2014/0308553 A1
(43) Pub. Date: Oct. 16, 2014

(54) SECONDARY BATTERY MODULE AND MANAGEMENT METHOD THEREOF

(71) Applicant: SAMSUNG SDI CO., LTD., Yongin-si (KR)

(72) Inventor: Hyungho KIM, Yongin-si (KR)

(73) Assignee: SAMSUNG SDI CO., LTD., Yongin-si (KR)

(21) Appl. No.: 14/056,401

(22) Filed: Oct. 17, 2013

Related U.S. Application Data
(60) Provisional application No. 61/811,944, filed on Apr. 15, 2013.

(51) Int. Cl. H01M 2/10; H01M 2/12

(52) U.S. Cl. CPC H01M 2/1077; H01M 2/12
USPC 429/89; 429/99; 29/623.1

(57) ABSTRACT

A housing for battery cells includes a tray including a body part having a central hole therein and blade part extending from the body part away from the central hole, a frame including a plurality of accommodation parts, each accommodation part configured to receive a battery cell, the frame being mounted on the blade part, and a case configured to receive the tray and the frame.

### CROSS-REFERENCE TO RELATED APPLICATION

The present application claims priority under 35 U.S.C. §119 to U.S. Provisional Application No. 61/811,944, filed on Apr. 15, 2013, and entitled: “Secondary Battery Module and Management Method Thereof,” which is incorporated herein by reference in its entirety.

### FIELD

Embodiments relate to a rechargeable secondary battery module and management method thereof.

### DESCRIPTION OF THE RELATED ART

In general, secondary batteries may be repeatedly charged and discharged. A single unit cell secondary battery is typically used in small portable electronic devices, such as cellular phones, notebook computers, camcorders, and the like. A secondary battery module including a plurality of connected unit cells is typically used as a motor driving power source for hybrid electric vehicles (HEVs), electric vehicles (EVs), and the like.

Since the secondary battery module is constituted by connecting several to several tens of battery cells, it may include a cooling system, a safety device, a system circuit, etc. configured to easily emit heat generated from each battery cell. In particular, high-output, large-capacity secondary battery modules used for HEVs or EVs need to be easily maintained and repaired while having improved heat emission property.

### SUMMARY

One or more embodiments are directed to a housing for battery cells. The housing may include a tray including a body part having a central hole therein and blade part extending from the body part away from the central hole, a frame including a plurality of accommodation parts, each accommodation part configured to receive a battery cell, the frame being mounted on the blade part, and a case configured to receive the tray and the frame.

The case may include a vent.

The case may include a lower case supporting the tray and the frame, and surrounding the tray and the frame, and an upper case covering the tray and the frame.

The vent may be in the upper case.

The vent may be aligned with the central hole.

The upper case may have a height relative to the lower case that increases from where the upper case contacts the lower case to the vent.

The vent may include a plurality of through holes in the lower case.

The accommodation parts may be arranged around the central hole of the body part, at least a portion of the accommodation parts further from the body part being spaced apart.

The frame may further include connection parts connecting adjacent accommodation parts at ends thereof furthest from the body part.

Each accommodation part may include four side surfaces configured to overlap side surfaces of the battery cell therein.

The frame may further include a detachable cover corresponding to each accommodation part.

The detachable cover may include a groove configured to allow a bus bar connecting battery cells in adjacent accommodation parts to protrude.

The blade part may include passages overlapping spacing between the accommodation parts.

The tray may include a rotation part that extends downward from the body part to the blade part, the rotation part being connected to the blade part being configured to allow the blade part and the rotation part to rotate around the body part.

The case may be configured to partially open to allow access, along with rotation of the blade part, to individual accommodation parts.

The case may include a protrusion configured to slidably open the case.

The frame may include an opening configured to receive a battery management system.

The battery management system may be removably received in the opening.

The housing may include a plurality of stacked trays and corresponding frames and detachable bus bars connecting adjacent stacked frames.

The body part may include a stepped part at an upper surface thereof and a protrusion part at a lower surface thereof and extending beyond the blade part, wherein the stepped portion and the protrusion part of adjacent body parts abut to secure stacked trays.

Each tray may include a rotation part that extends downward from the body part to the blade part, the rotation part being connected to the blade part being configured to allow the blade part and the rotation part to rotate around the body part, the tray being independently rotatable.

Each frame and tray may each include an opening configured to receive a battery management system.

One or more embodiments are directed to a method of managing a secondary battery module including a plurality of battery cells and a housing for the plurality of battery cells. The method may include opening a case of the housing surrounding the plurality of battery cells and rotating a tray of the housing on which a target battery cell is located to access the target battery cell.

The method may further include a plurality of stacked trays, each tray including a body part having a central hole therein and blade part extending from the body part away from the central hole, a frame including a plurality of accommodation parts, each accommodation part configured to receive a battery cell, the frame being mounted on the blade part, and detachable bus bars connecting adjacent stacked frames, wherein the method further includes, before rotating the tray on which the target battery cell is located, removing bus bars connected to that tray.

Each accommodation part may include a detachable cover, wherein the method further includes, after rotating the tray on which the target battery is located, removing the detachable cover covering the target battery.

### BRIEF DESCRIPTION OF THE DRAWINGS

Features will become apparent to those of skill in the art by describing in detail exemplary embodiments with reference to the attached drawings in which:

FIG. 1 illustrates an exploded perspective view of a secondary battery module according to an embodiment;

FIG. 2 illustrates a cross-sectional view of the secondary battery module according to an embodiment;

FIG. 3 illustrates an enlarged cross-sectional view of a portion ‘A’ shown in FIG. 2;

FIGS. 4a and 4b illustrate a perspective view and a plan view of a frame shown in FIG. 1;

FIGS. 5a and 5b illustrate a perspective view and a cross-sectional view of a tray shown in FIG. 1;

FIG. 6 illustrates a perspective view illustrating another example of the tray shown in FIG. 5a;

FIG. 7 illustrates a perspective view illustrating another example of the case shown in FIG. 1; and

FIGS. 8a to 8c illustrate a management method of a secondary battery module according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

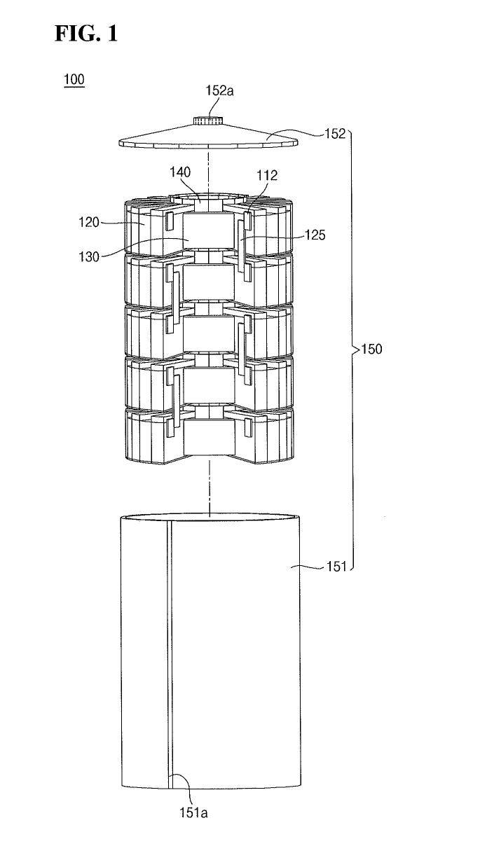

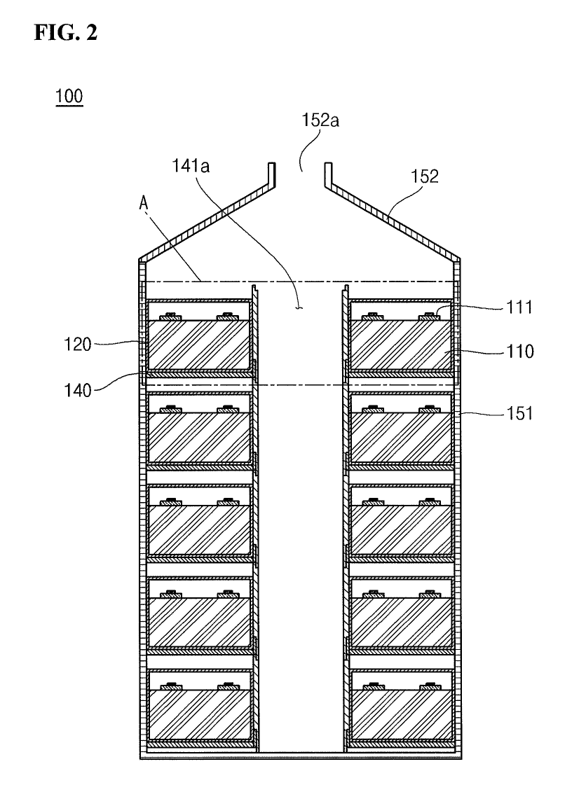

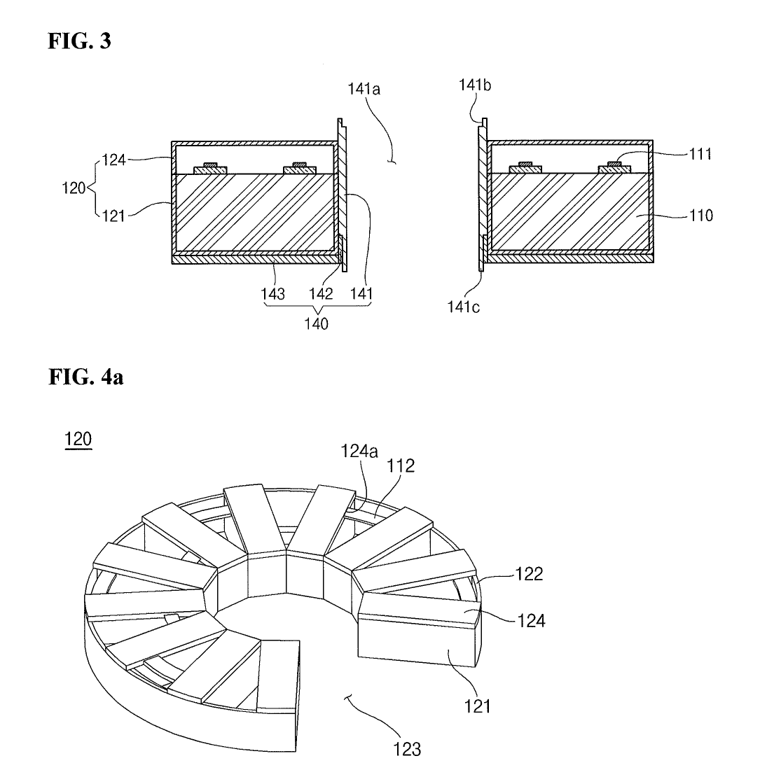

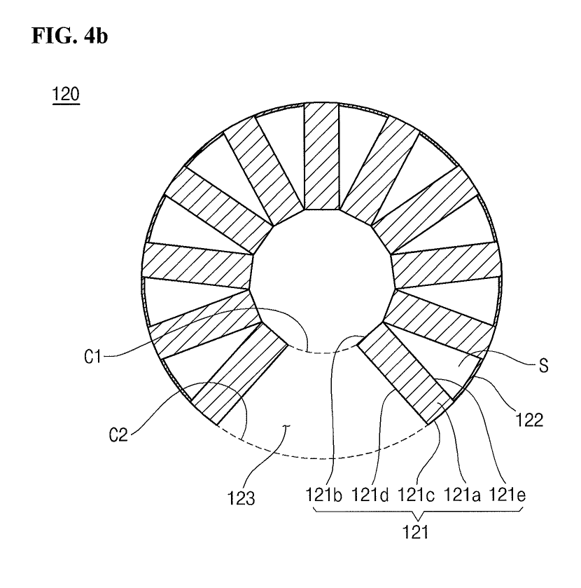

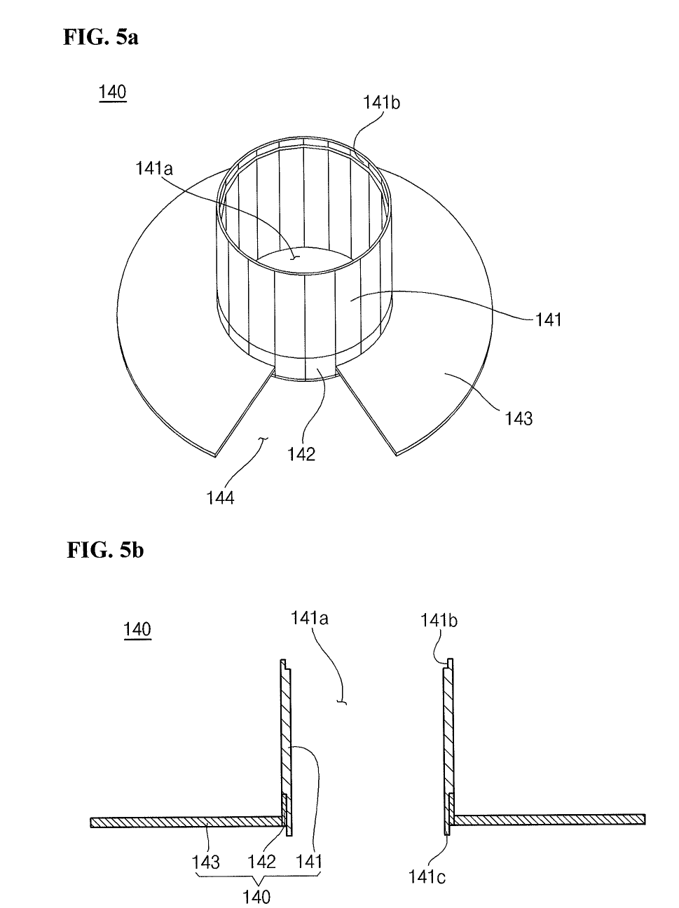

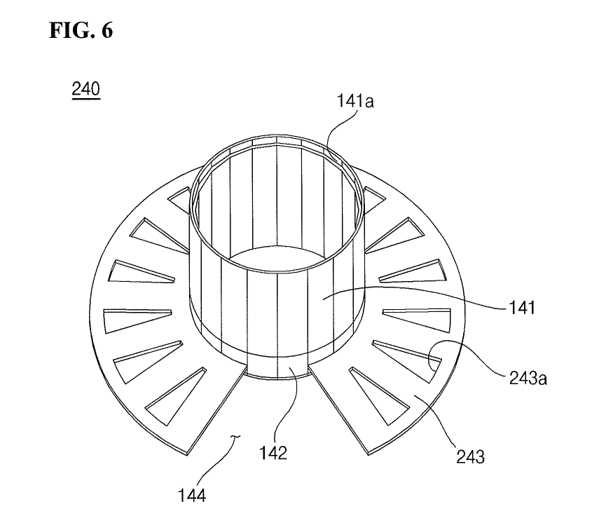

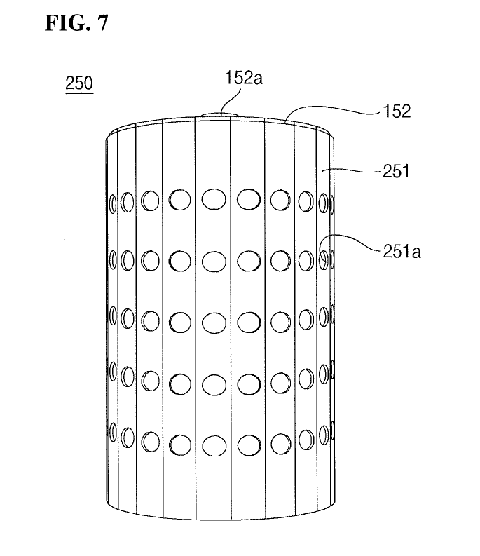

FIG. 1 illustrates an exploded perspective view of a secondary battery module according to an embodiment. FIG. 2 illustrates a cross-sectional view of the secondary battery module according to an embodiment. FIG. 3 illustrates an enlarged cross-sectional view of a portion ‘A’ shown in FIG. 2. FIGS. 4a and 4b illustrate a perspective view and a plan view of a frame shown in FIG. 1. FIGS. 5a and 5b illustrate a perspective view and a cross-sectional view of a tray shown in FIG. 1. FIG. 6 illustrates a perspective view of another example of the tray shown in FIG. 5a. FIG. 7 illustrates a perspective view of another example of the case shown in FIG. 1.

Referring to FIGS. 1 to 3, the secondary battery module 100 according to an embodiment includes a plurality of battery cells 110, a frame 120, a battery management system 130, a tray 140, and an external case 150.

Each of the battery cells 110 includes an electrode assembly formed by a positive electrode plate, a negative electrode plate, and a separator as an insulator positioned between the positive electrode plate and the negative electrode plate, a case providing a space in which the electrode assembly is placed, a cap assembly coupled to and sealing the case, and electrode terminals 111 protruding toward an upper portion of the cap assembly and electrically connected to the positive electrode plate and the negative electrode plate of the electrode assembly, respectively. The electrode terminals 111 include a positive electrode terminal connected to the positive electrode plate and a negative electrode terminal connected to the negative electrode plate. In addition, the battery cells 110 are inserted into the frame 120 and are electrically connected to each other through a bus bar 112. The plurality of battery cells 110 may be connected in series or in parallel to each other through the bus bar 112. The plurality of battery cells 110 connected to each other may be used as a motor driving power source for a hybrid electric vehicle (HEV), an electric vehicle (EV), or the like.

The plurality of battery cells 110 are accommodated in the frame 120. Referring to FIGS. 4a and 4b, the frame 120 may be a cylinder, and may include accommodation parts 121, connection parts 122, a first opening part 123, and a cover 124.

The accommodation parts 121 are areas in which the battery cells 110 are accommodated. Each of the accommodation parts 121 may be box shaped having an open top end. When box shaped, the accommodation part 121 includes a bottom surface 121a and four side surfaces 121b, 121c, 121d, and 121e upwardly extending from the bottom surface 121a. The side surfaces 121b, 121c, 121d, and 121e include first and second short side surface 121b and 121c facing each other, and first and second long side surfaces 121d and 121e connecting the first and second short side surfaces 121b and 121c and facing each other. In addition, a plurality of the accommodation parts 121 may be provided to accommodate the plurality of battery cells 110 and may be arranged to form a circle by connecting the first short side surfaces 121b thereof to each other. Accordingly, the second short side surfaces 121c of the respective accommodation parts 121 are formed to be spaced apart from each other.

The connection parts 122 may connect the second short side surfaces 121c of the respective accommodation parts 121, resulting in a triangular or fan-shaped space S being formed between neighboring accommodation parts 121. The space S serves to emit heat generated from the battery cells 110. In addition, the frame 120 includes an inner circle C1 formed by connecting the first short side surfaces 121b and an outer circle C2 formed by connecting the second short side surfaces 121c and the connection parts 122. Here, the inner circle C1 and the outer circle C2 are concentrically formed to have the same center while having different radii. In addition, the accommodation parts 121 and the connection parts 122 may be integrally formed.

The first opening part 123 without the accommodation parts 121 and the connection parts 122 is formed at one side of the frame 120. The battery management system 130 described below may be mounted in the first opening part 123. In addition, the first opening part 123 serves as a passageway through which the battery cells 110 may be taken out.

The cover 124 is coupled to a top surface of the accommodation part 121. In addition, the cover 124 may have a groove 124a from which the bus bar 112 connected to the electrode terminal 111 of the battery cell 110 protrudes.

The battery management system (BMS) 130 is disposed in the first opening part 123 and controls the plurality of battery cells 110 accommodated in the frame 120. In particular, the BMS 130 may control charging/discharging of the plurality of battery cells 110. In addition, the BMS 130 may detect abnormal battery cells among the plurality of battery cells 110.

The frames 120 are mounted in the trays 140. A plurality of trays 140 may be stacked to then be housed in the external case 150. Therefore, a plurality of frames 120 may also be mounted in the plurality of trays 140. The plurality of frames 120 may be electrically connected to each other through a frame bus bar 125. In addition, the stacked trays 140 may be formed to be independently rotatable. Therefore, the battery cells 110 may be easily detached from the frames 120 mounted in the independently rotating trays 140 for replacement. The replacement of the battery cells 110 will be described below in more detail.

Referring to FIGS. 5a and 5b, each of the trays 140 includes a body part 141, a rotation part 142, and a blade part 143.

The body part 141 may be a cylinder having a center hole 141a in a center thereof. Therefore, a section taken in a horizontal direction of the body part 141 is shaped of a ring having an inner hollow portion. The body part 141 serves as a major axis column of the tray 140, and the center hole 141a serves as a passageway for emitting the heat generated from the battery cells 110. In addition, the body part 141 may include a stepped part 141b inwardly stepped at a top end of the body part 141 and a downwardly protruding protrusion part 141c at a bottom end of the body part 141. The stepped part 141b may be coupled to the protrusion part of the tray coupled to a top end, and the protrusion part 141c may be coupled to the stepped part of the tray coupled to a bottom end. The stepped part 141b and the protrusion part 141c formed in the body part 141 serve to fix the stacked trays 140, i.e., prevent the stacked trays from rotating. In particular, sections taken along horizontal directions of the stepped part 141b and the protrusion part 141c are polygonal, rather than circular. Thus, the stepped part 141b and the protrusion part 141c are shaped of polygons including of multiple linear sections, thereby preventing the stacked trays 140 from rotating.

The rotation part 142 is formed at the bottom end of the body part 141, and the blade part 143 extends in a horizontal direction of the rotation part 142. The rotation part 142 and the blade part 143 may be integrally formed and capable of rotating about the body part 141. That is to say, if the blade part 143 is rotated, it rotates at a lower portion of the body part 141 along with the rotation part 142 connected to the blade part 143. The frame 120 is mounted in the blade part 143, and the blade part 143 is formed to correspond to the frames 120. Therefore, the blade part 143 includes a second opening part 144 having one side opened to corresponding to the first opening part 123 of the frame 120

As shown in FIG. 6, another exemplary tray 240 according to an embodiment includes a blade part 243 having a plurality of throughholes 243a. The throughholes 243a may be formed in the tray 120 to correspond to the space S formed between the accommodation parts (121 of FIG. 4b), i.e., each of the throughholes 243a may be triangular or fan-shaped. The throughholes 243a serve as passageways for emitting heat generated from the battery cells 110.

Referring again to FIG. 1, the external case 150 houses the battery cells 110, the frames 120, the BMS 130, and the trays 140. The external case 150 may include a lower external case 151 and an upper external case 152 coupled to the lower external case 151.

The lower external case 151 may be a cylinder having an open top end to accommodate the battery cells 110, the frames 120, the BMS 130, and the trays 140. In addition, the lower external case 151 may be opened or closed in a sliding manner. In addition, a protrusion part 151a is formed in the lower external case 151 to open the lower external case 151 in a sliding manner. Therefore, if a user grabs the protrusion part 151a and pushes the same sideways, the lower external case 151 is slidably opened. Here, the lower external case 151 may be opened at a maximum angle of 180 degrees. The protrusion part 151a facilitates opening/closing of the external case 151.

The upper external case 152 is coupled to an upper portion of the lower external case 151. Heights of the upper external case 152 may be configured to gradually increase toward the center. In addition, a vent 152a may be formed at the center of the upper external case 152. The vent 152a is provided to emit the heat generated from the battery cells 110 housed in the case 150. In addition, since the vent 152a is aligned with center hole 141a formed inside the body part 141, heat generated from the battery cells 110 may be easily emitted to the outside. Further, a fan (not shown) may be provided within the upper external case 152 to speed emission of heat generated from the battery cells 110 housed in the case 150.

In addition, as shown in FIG. 7, the external case 250 includes a lower external case 251 having a plurality of discharge holes 251a. The discharge holes 251a allow the heat generated from the battery cells 110 housed in the external case 250.

As described above, since the secondary battery module 100 according to an embodiment includes the tray 140 having the center hole 141a formed therein and the case 150 having the vent 152a, heat generated from the battery cells 110 may be rapidly emitted to the outside. In addition, since the secondary battery module 100 according to an embodiment includes the frame 240 having the throughholes 243a and the case 250 having the discharge holes 251a, the heat generated from the battery cells 110 may be rapidly emitted to the outside. Further, the secondary battery module 100 according to an embodiment may improve cycle life characteristics of the battery cells 110 and improve safety of the battery cells 110.

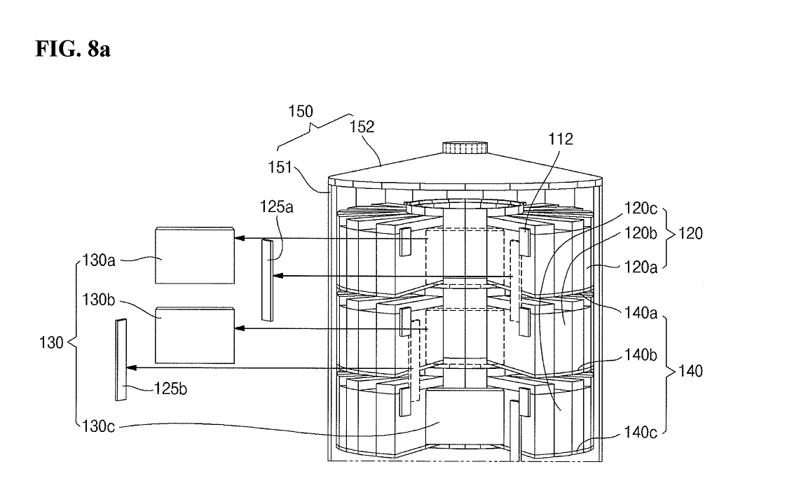

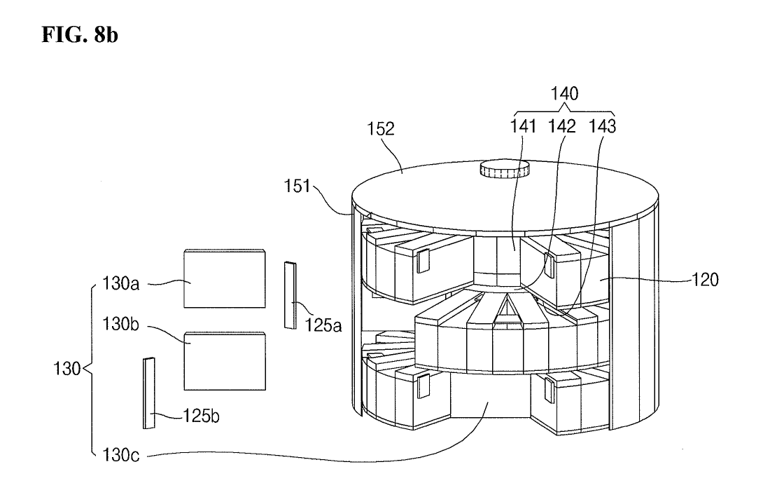

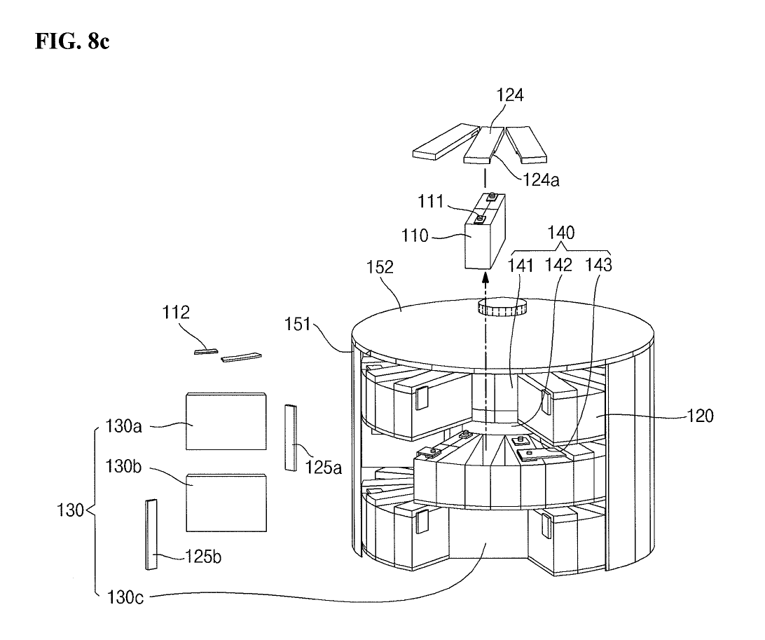

FIGS. 8a to 8c illustrate a management method of a secondary battery module according to an embodiment.

First, the trays 140 are sequentially defined as a first tray 140a, a second tray 140b, and a third tray 140c, in that order, from the top portion of the case 150. In addition, battery management systems 130 are also sequentially defined as a first battery management system 130a, a second battery management system 130b, and a third battery management system 130c, in that order, from the top portion of the case 150. Further, frames 120 mounted in the first tray 140a are defined as first frames 120a, frames 120 mounted in the second tray 140b are defined as second frames 120b, and frames 120 mounted in the third tray 140c are defined as third frames 120c, respectively. In addition, the first frames 120a and the second frames 120b are electrically connected through a first tray bus bar 125a, and the second frames 120b and the third frames 120c are electrically connected through a second tray bus bar 125b. Here, the tray bus bars 125a and 125b are electrically connected to bus bars 112 connected to the electrode terminals 111 of the battery cells 110.

Here, assuming that one of the battery cells 110 housed in the second frame 120b is an abnormal battery cell, the management method of the secondary battery module will now be described. While the management method is described below relative to a detected abnormal battery cell, access to the different battery cells may be realized in connection with any target battery cell, e.g., based on detected abnormality, age, capacity, etc.

Referring to FIG. 8a, the second battery management system 130b detects the abnormal battery cell and notifies the user of the detection result. The user opens the lower external case 151 in a sliding manner to separate the second battery management system 130b and the first battery management system 130a from each other. As described above, a space required for taking the abnormal battery cell out may be secured by separating the second battery management system 130b and the first battery management system 130a. In addition, the first tray bus bar 125a and the second tray bus bar 125b connected to the second frame 120b are also separated from the second frame 120b. Accordingly, the second tray 140b may be independently rotated.

Next, referring to FIG. 8b, the second tray 140b is rotated to allow the abnormal battery cell to be positioned at a portion from which the first battery management system 130a is detached.

Next, referring to FIG. 8c, the cover 124 of the accommodation part accommodating the abnormal battery cell is separated. Covers 124 of battery cells positioned at opposite sides of, e.g., directly adjacent, the abnormal battery cell may also be separated to further facilitate removal of the abnormal battery cell. Then, the bus bar 112 connected to the electrode terminals 111 of the abnormal battery cell is separated, and the abnormal battery cell is then removed through a portion from which the first battery management system 130a is detached. The abnormal battery cell may be replaced with a new battery cell. Next, a maintenance and repair procedure of the secondary battery module 100 may be completed by reassembling the secondary battery module 100 in the reverse order to disassembling thereof to remove the abnormal battery cell.

As described above, in the management method of a secondary battery module according to an embodiment, the secondary battery module includes the rotatable tray 140, thereby easily replacing battery cells 110. In addition, in the management method of a secondary battery module according to an embodiment, the secondary battery module includes the case 150 that may be readily opened or closed, e.g., in a sliding manner, thereby allowing access to battery cells 110, irrespective of location.

By way of summation and review, the secondary battery module according to one or more embodiments may be conveniently maintained and repaired. It is a feature of an embodiment to provide a secondary battery module, which may easily emit heat generated from a battery cell and may be conveniently maintained and repaired, and a management method thereof Further, in the management method of a secondary battery module, the secondary battery module includes a rotatable tray and a case opened or closed in a sliding manner, thereby easily replacing battery cells.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A housing for battery cells, comprising:
a tray including a body part having a central hole therein and a blade part extending from the body part away from the central hole;
a frame including a plurality of accommodation parts, each accommodation part configured to receive a battery cell, the frame being mounted on the blade part; and
a case configured to receive the tray and the frame.

2. The housing as claimed in claim 1, wherein the case includes a vent.

3. The housing as claimed in claim 2, wherein the case includes:
a lower case supporting the tray and the frame, and surrounding the tray and the frame; and
an upper case covering the tray and the frame.

4. The housing as claimed in claim 3, wherein the vent is in the upper case.

5. The housing as claimed in claim 4, wherein the vent is aligned with the central hole.

6. The housing as claimed in claim 5, wherein the upper case has a height relative to the lower case that increases from where the upper case contacts the lower case to the vent.

7. The housing as claimed in claim 3, wherein the vent includes a plurality of through holes in the lower case.

8. The housing as claimed in claim 1, wherein the accommodation parts are arranged around the central hole of the body part, at least a portion of the accommodation parts further from the body part being spaced apart.

9. The housing as claimed in claim 8, wherein the frame further includes connection parts connecting adjacent accommodation parts at ends thereof furthest from the body part.

10. The housing as claimed in claim 8, wherein each accommodation part includes four side surfaces configured to overlap side surfaces of the battery cell therein.

11. The housing as claimed in claim 10, wherein the frame further includes a detachable cover corresponding to each accommodation part.

12. The housing as claimed in claim 11, wherein the detachable cover includes a groove configured to allow a bus bar connecting battery cells in adjacent accommodation parts to protrude.

13. The housing as claimed in claim 8, wherein the blade part includes passages overlapping spacing between the accommodation parts.

14. The housing as claimed in claim 1, wherein the tray includes a rotation part that extends downward from the body part to the blade part, the rotation part being connected to the blade part being configured to allow the blade part and the rotation part to rotate around the body part.

15. The housing as claimed in claim 14, wherein the case is configured to partially open to allow access, along with rotation of the blade part, to individual accommodation parts.

16. The housing as claimed in claim 1, wherein the frame and the tray each include an opening configured to receive a battery management system.

17. The housing as claimed in claim 16, wherein the battery management system is removably received in the opening.

18. The housing as claimed in claim 1, further comprising:
a plurality of stacked trays and corresponding frames; and
detachable bus bars connecting adjacent stacked frames.

19. The housing as claimed in claim 18, wherein the body part includes a stepped part at an upper surface thereof and a protrusion part at a lower surface thereof and extending beyond the blade part, wherein the stepped part and the protrusion part of adjacent body parts abut to secure stacked trays.

20. The housing as claimed in claim 19, wherein each tray includes a rotation part that extends downward from the body part to the blade part, the rotation part being connected to the blade part and being configured to allow the blade part and the rotation part to rotate around the body part, the tray being independently rotatable.

21. The housing as claimed in claim 18, wherein each frame and tray includes an opening configured to receive a battery management system.

22. A method of managing a secondary battery module including a plurality of battery cells and a housing for the plurality of battery cells, the method comprising:
opening a case of the housing surrounding the plurality of battery cells; and
rotating a tray of the housing on which a target battery cell is located to access the target battery cell.

23. The method as claimed in claim 22, wherein the housing includes:
a plurality of stacked trays, each tray including a body part having a central hole therein and blade part extending from the body part away from the central hole;
a frame including a plurality of accommodation parts, each accommodation part configured to receive a battery cell, the frame being mounted on the blade part; and
detachable bus bars connecting adjacent stacked frames, wherein the method further includes, before rotating the tray on which the target battery cell is located, removing bus bars connected to that tray.

24. The method as claimed in claim 22, wherein each accommodation part includes a detachable cover, wherein the method further includes, after rotating the tray on which the target battery is located, removing the detachable cover covering the target battery.
